(19) United States
(12) Patent Application Publication
(10) Pub. No.: US 2025/0117732 A1
(43) Pub. Date: Apr. 10, 2025

(54) METHOD AND DEVICE FOR EVALUATING ECOLOGICAL CUMULATIVE EFFECTS OF SURFACE MINING AREAS

(71) Applicant: China University of Mining and Technology, Beijing (CN)

(72) Inventors: Jing Li, Beijing (CN); Jiaxin Liang, Beijing (CN); Jiangrun Huo, Beijing (CN); Xingguang Yan, Beijing (CN); Tianyue Ma, Beijing (CN)

(21) Appl. No.: 18/898,719

(22) Filed: Sep. 27, 2024

(30) Foreign Application Priority Data
Sep. 28, 2023 (CN) 2023112804953

(51) Int. Cl. G06Q 10/0639; G06Q 50/02

(52) U.S. Cl. CPC G06Q 10/06393; G06Q 50/02

(57) ABSTRACT

A method and device for evaluating ecological cumulative effects of surface mining areas are provided. The method includes: constructing a surface mining areas eco-environmental evaluation index (SMAEEI) suitable for semi-arid grasslands; constructing a first eco-environmental quality condition adjustment coefficient R(Si,j,tₕ) based on the actual land cover classification result and the SMAEEI; obtaining the actual ecosystem service value ESV per unit area of the area to be evaluated in several years through the unit area ecosystem service value coefficient VC_{if} of the area to be evaluated and the first eco-environmental quality condition adjustment coefficient R(Si,j,tₕ); based on the time-series trajectory integral value of the actual ecosystem service value ESV per unit area and the ideal ecosystem service value ESV′ per unit area undisturbed by human beings, performing residual analysis to obtain the ecosystem service value accumulation induced by anthropogenic factors (ESVA-AF).

### TECHNICAL FIELD

One or more embodiment of the specification relates to the technical field of ecological evaluation, in particular to a method and device for evaluating ecological cumulative effects of surface mining areas.

### BACKGROUND

The grassland mining area is located in a semi-arid and arid climate zone and is characterized by fragile ecological features such as loose surface material structure and poor soil. Despite these challenges, it bears the heavy responsibilities of developing mining, animal husbandry, urban areas, and agriculture. Large-scale, high-intensity open-pit coal mining and the parallel development of related industrial chains have disrupted the original balance of the grassland ecosystem, leading to complex and diverse ecological cumulative issues such as surface damage, vegetation destruction, and degradation of ecosystem functions. Monitoring the changes in the ecological environment quality of the semi-arid grassland surface mining area and investigating the trends of ecological cumulative effects can provide technical support for identifying ecological damage and its cumulative losses, calculating ecosystem functions and their losses, and planning resource development.

Based on the evaluation subjects, the current quantitative assessment of ecological cumulative effects in mining areas primarily focuses on two aspects. The first is the cumulative impact of mining activities on individual environmental elements (such as vegetation, soil, surface temperature, etc.). This involves using methods such as trend line analysis to reveal the extent of mining disturbances to vegetation, combining geochemical accumulation index methods and factor analysis to explore changes in soil properties during the mining process, and employing remote sensing time series analysis to monitor changes in surface temperature and humidity caused by mining activities. Although these methods emphasize long-term monitoring and help to thoroughly uncover the impact trends of mining activities on specific environmental elements, they do not take into account the systematic impact on multiple environmental elements, making it difficult to comprehensively quantify the cumulative effects of mining activities on the ecological environment.

The second aspect focuses on the comprehensive cumulative impact of mining area development on the overall ecological environment. For instance, the invention patent Evaluation Method, Device, Equipment and Storage Media of Ecological cumulative effects in Coal Mining Areas (CN 112001650 A) constructs evaluation models for the ecological cumulative effects in coal mining areas corresponding to multiple mining plans based on the standardized matrix of multiple mining schemes and the weights of their multiple index factors. This patent considers the ecological and environmental differences of different mining schemes, emphasizing the flexibility and causality of index selection, and can comprehensively reflect environmental effects such as hydrology, geology, resource consumption, biology, and pollution caused by coal development. However, it uses the region as the evaluation unit, resulting in evaluation outcomes that lack spatial visualization and cannot measure or capture the spatial differences in the ecological cumulative effects of the mining area.

Additionally, the invention patent An Evaluation Method of Ecological cumulative effects in Mining Areas (CN 113240296 A) selects suitable indicators from four aspects: landscape pattern disturbance, vegetation degradation, soil erosion, and air pollution, to construct an evaluation model for the ecological cumulative effects in arid and semi-arid mining areas. This model characterizes the ecological cumulative losses in mining areas caused by coal resource development activities. While this patent can provide comprehensive information on the ecological environment quality of mining areas from a large spatiotemporal scale and ecological environment constraint perspective, it relies on static temporal phase stock comparisons, resulting in insufficient dynamic assessment over time and a lack of description of the cumulative change process.

Another example is (LI Jing, LIANG Jiaxin, WU Yue, et al. Quantitative evaluation of ecological cumulative effect in mining area using a pixel-based time series model of ecosystem service value [J]. ecological indicators, 2021,120: 106873.) Taking pixels as the evaluation units, taking the whole research period as the evaluation scale, and taking the ecosystem service value as the evaluation index, change of ecosystem service value cumulant (COESVC)—the difference between actual ecosystem service value cumulant (AESVC) and ideal ecosystem service value cumulant (IESVC)—is used to represent the ecological cumulative effects in mining areas. The model realizes dynamic evaluation on time scale, and can reveal the direction, degree and spatial differentiation characteristics of cumulative effects. However, the model explores the ecological cumulative relative variation (that is, the ecological accumulation from the initial stage to the final stage is calculated based on the initial stage of ecosystem), which leads to the fact that it does not consider the cumulative impact of human activities that existed before initial stage and the change of natural factors during the monitoring period. The ecological disturbance caused by natural factors and human factors is not separated, which leads to the inability to accurately evaluate the ecological cumulative effects of mining areas caused by human activities. In addition, the method of taking the remote sensing based ecological index (RSEI) as the adjustment coefficient of ecological environment quality in the model is not necessarily suitable for semi-arid grassland surface mining areas. The RSEI focusing on urban environment can not accurately reflect the ecological environment characteristics of semi-arid grassland surface mining areas, and the index is constructed by the first principal component (PC1) of principal component analysis (PCA) based on multiple indexes, which has insufficient information utilization and random direction.

In summary, the existing methods for assessing the ecological cumulative effects in mining areas primarily face the following issues:

(1) Lack of comprehensive consideration of environmental elements. While quantitative research methods for the ecological cumulative effects of mining on individual environmental elements are well-developed, they do not account for the systematic impact on multiple environmental elements. This makes it difficult to comprehensively quantify the cumulative effects of mining activities on the overall ecological environment.

(2) Lack of spatial visualization of assessment results. Many existing assessment units are either the entire mining area or specific landscape types, leading to results that lack spatial visualization. Consequently, these methods cannot measure or capture the spatial differences in the ecological cumulative effects within the mining area.

(3) Insufficient dynamism and rationality in temporal assessments. Static temporal phase comparisons focus on the magnitude of cumulative effects, neglecting the dynamic changes in cumulative impacts on the ecological environment due to long-term coal mining. Furthermore, for regions where mining activities had already commenced at the beginning of the study, using the study's initial phase as a baseline fails to account for the historical impacts of human activities, making it challenging to accurately capture the degree of cumulative impact from mining-related human activities.

(4) Uncertainty in the application of assessment indicators. Assessment indicators may have localized applicability, and their indiscriminate use could lead to biased or unfair assessment results.

(5) Lack of separation between human-induced and natural cumulative impacts. Current methods do not account for changes due to natural factors during the monitoring period, nor do they distinguish between disturbances caused by natural factors and those caused by human activities. This hinders accurate evaluation of the extent and range of cumulative ecological impacts attributable to human activities in mining areas.

These issues result in the inability of current methods for assessing the ecological cumulative effects in mining areas to precisely calculate the environmental damage costs caused by human activities and effectively identify the evolving trends of ecological cumulative effects, thus failing to meet practical needs.

### SUMMARY

The disclosure describes a method and device for evaluating the ecological cumulative effects of surface mining areas, and relates to a method and device for evaluating the ecological cumulative effects of surface mining areas with five dimensions of time, space, elements, physical quantity and value quantity. They can solve the technical problems and realize the following objectives.

(1) Technical Specifications for the Ecological Protection, Restoration and Remediation of Mining Areas (Trial) points out that the quality of mine ecological environment should be monitored, inspected and supervised regularly. In addition, the Evaluation Index of Environmental-Friendly Mine Construction takes environmental management and monitoring as secondary indicators, emphasizing the dynamic monitoring of water, soil, atmosphere, vegetation and other factors in mining areas. According to the disclosure, the background characteristics of semi-arid grassland, eco-environmental factors and surface mining influence are comprehensively considered, and a surface mining areas eco-environmental evaluation index (SMAEEI) and a quantitative evaluation model for ecological cumulative effects in surface mining area suitable for semi-arid grassland are put forward. Their evaluation results can be used as basic information for the dynamic monitoring of eco-environmental quality status and the evaluation of green construction in the surface mining area of semi-arid grassland.

(2) The Recommended Method for Appraisal and Evaluation of Environmental Damage (Second Edition) requires to evaluate the scope and degree of environmental damage caused by environmental pollution or ecological destruction, and quantify the amount of environmental damage. The quantitative evaluation model for ecological cumulative effects in surface mining area constructed by the disclosure attempts to convert the physical changes of ecological environment caused by human activities in mining area (such as changes in land cover and quality of ecological environment) into value descriptions (such as ecosystem service value), and to represent the ecological environment damage cost of surface mining area, the change degree and spatial range of ecosystem service value and its accumulation through monetization.

(3) The ecological cumulative effects of mining area pay attention to the continuous, incremental and comprehensive impacts on the regional ecological environment caused by various past, present and foreseeable human behaviors, which are mainly based on the exploitation of mineral resources. However, the existing methods often confuse the cumulative impacts caused by natural factors and human factors. According to the disclosure, the quantitative evaluation model for ecological cumulative effects in surface mining area is constructed based on pixels, and the natural ecosystem state without human interference is taken as the baseline to separate the ecological cumulative effects of natural factors and human factors. The model is helpful for objectively understanding the ecological environment accumulation influence of human activities in mining area and its differences, and the results can provide a basis for optimizing human activities in mining area from the aspects of time sequence, layout, scale and the like.

(4) The draft of Technical Specification for Accounting of Gross Ecosystem Product Assessment (GEP) points out that when accounting for the supporting role of ecosystem in human welfare and economic and social development, GEP should account for the sum of ecosystem service value of material products, regulatory services and cultural services. When assessing the effectiveness of ecological protection and the ecological benefits of regional units at all levels, only the value of ecosystem regulation services and cultural services can be accounted for. This disclosure constructs a quantitative evaluation model for ecological cumulative effects in surface mining areas based on four ecosystem service functions of supply, regulation, support and culture. The evaluation result, the accumulation of ecosystem service value induced by anthropogenic factors (ESVA-AF), can provide long-term auxiliary data for calculating the GEP of mining areas from the perspectives of economic and social development, ecological protection effectiveness and ecological benefits. It is also helpful for reasonably making ecological protection compensation mechanisms in mining areas.

According to the first aspect, the disclosure provides an evaluation method of ecological cumulative effects of surface mining areas, which takes a semi-arid grassland surface mining area as an area to be evaluated. The method includes: 1) constructing several remote sensing indexes and normalizing them respectively to obtain the maximum and minimum values corresponding to each remote sensing index; 2) based on the maximum and minimum values of the remote sensing indexes, the surface mining areas eco-environmental evaluation index (SMAEEI) is obtained by using the ecological distance index model of remote sensing; 3) several monthly values of temperature and precipitation with the highest and second highest correlation with SMAEEI are screened out, and the linear regression equation of SMAEEI with the above monthly values of temperature and precipitation is constructed by using multiple regression model, so as to obtain the simulated eco-environmental quality value SMAEEI′ under the influence of climate factors; 4) acquiring an ecosystem service value equivalent coefficient E_{if} of the f-th ecosystem service function of the land cover type j in the area to be evaluated; 5) based on the E_{if} and the preset standard ecosystem service value equivalent factor C_{crop} per unit area, the unit area ecosystem service value coefficient VC_{if} of the area to be evaluated is obtained; 6) constructing a first eco-environmental quality condition adjustment coefficient R(Si,j,tₕ) based on the actual land cover classification result and SMAEEI; 7) obtaining the actual ecosystem service value ESV per unit area of the area to be evaluated in several years through the unit area ecosystem service value coefficient VC_{if} of the area to be evaluated and the first eco-environmental quality condition adjustment coefficient R(Si,j,tₕ); 8) based on the classification results of ideal land cover undisturbed by human beings and the simulated eco-environmental quality value SMAEEI′ in several years, the second eco-environmental quality condition adjustment coefficient R(Si,j,tₕ)′ is constructed; 9) obtaining the ideal ecosystem service value ESV′ per unit area of the area to be evaluated in several years through the unit area ecosystem service value coefficient VC_{if} of the area to be evaluated and the second eco-environmental quality condition adjustment coefficient R(Si,j, tₕ)′; 10) obtaining the Ecosystem Service Value Accumulation Induced by Natural Factors (ESVA-NF) based on the ideal ecosystem service value ESV′ per unit area; 11) based on the actual ecosystem service value ESV per unit area, the Ecosystem Service Value Accumulation Induced by Multiple Factors (ESVA-MF) is obtained; 12) residual analysis is carried out by using the ESVA-MF and the ESVA-NF to obtain the ecosystem service value accumulation induced by anthropogenic factors, ESVA-AF.

In some embodiments, the remote sensing index includes related characterization parameters of land cover, soil characteristics, water environment, air pollution and vegetation status.

In some embodiments, the characterization parameters of land cover are biophysical composition index (BCI) and land surface temperature (LST), where BCI is constructed by the normalized brightness, greenness and wetness of tasseled cap transformation. The soil characteristics are characterized by modified salinization index (MSI). The water environment is characterized by surface potential water abundance index (SPWI). In the air pollution, the enhanced coal dust index (ECDI), which can effectively identify the ground information of coal dust pollution affected area, is used to identify the spatial distribution of coal dust pollution. The fractional vegetation cover (FVC) and vegetation health index (VHI) are selected to represent the vegetation status of surface mining areas.

In some embodiments, the ecological distance index model of remote sensing adopts the following formula:

$$SMAEEI = \sqrt{{( BCI - {BCI}_{max} )}^{2} + {( ECDI - {ECDI}_{max} )}^{2} + {( MSI - {MSI}_{max} )}^{2} + {( LST - {LST}_{max} )}^{2} + {( FVC - {FVC}_{min} )}^{2} + {( VHI - {VHI}_{min} )}^{2} + {( SPWI - {SPWI}_{min} )}^{2}}$$

where I, Iₘᵢₙ and Iₘₐₓ are the remote sensing index and its minimum value and maximum value, respectively,

$$I = \frac{I - {I}_{min}}{{I}_{max} - {I}_{min}} .$$

In some embodiments, FVC and VHI are selected to represent the vegetation status of surface mining areas. Specifically, FVC is constructed by pixel dichotomy, and VHI is constructed by normalized difference vegetation index (NDVI), normalized difference senescent vegetative index (NDSVI) and nitrogen reflectance index (NRI). NDVI, NDSVI and NRI are normalized first, then PC1 is obtained by principal component analysis (PCA), and finally PC1 is normalized to obtain VHI, wherein PC1 is a first component of the PCA.

In some embodiments, acquiring the ecosystem service value equivalent coefficient E_{if} of the f-th ecosystem service function of the land cover type j includes:
obtaining the ecosystem service value equivalent coefficient E_{if} of woodland, grassland, cropland, wetland, water bodies and barren land in land cover classification result, and the ecosystem service value equivalent coefficient E_{if} of mining land and developed land corresponding to gas regulation, waste treatment and water conservation in land cover classification result.

In some embodiments, the ecosystem service function includes at least one of the following aspects: gas regulation, climate regulation, water conservation, waste treatment, soil formation and protection, biodiversity protection, food production, raw material production, and entertainment and culture.

In some embodiments, the calculation formula of the simulated eco-environmental quality value SMAEEI′ is:

$${SMAEEI}^{′} = {a}_{1} {P}_{x} + {a}_{2} {P}_{y} + {b}_{1} {T}_{m} + {b}_{2} {T}_{n} + e$$

where Pₓ and P_{y} (Tₘ, Tₙ) are the two monthly precipitation values (monthly temperature values) with the highest correlation and the second highest correlation with SMAEEI respectively. a₁, a₂, b₁, b₂ and e are coefficients to be determined. The method for determining the values of the undetermined coefficients is as follows: substituting the SMAEEI average values of several years without human disturbance and the Pₓ average values, P_{y} average values, Tₘ average values and Tₙ average values of corresponding years into the linear regression equation to solve the values of the undetermined coefficients.

In an embodiment, the two monthly precipitation values and two monthly temperature values with the highest and second highest correlation with SMAEEI need to be determined according to the specific correlation evaluation results.

According to the second aspect, the disclosure provides a device for evaluating the ecological cumulative effects of surface mining area, which takes a surface mining area in a semi-arid grassland as an area to be evaluated, and the device comprises:
a surface mining areas eco-environmental evaluation index (SMAEEI) acquisition module, configured to construct a plurality of remote sensing indexes and normalize them respectively to obtain a maximum value and a minimum value corresponding to each remote sensing index; based on the maximum and minimum values of the remote sensing indexes, the SMAEEI is obtained by using the ecological distance index model of remote sensing;
a simulated eco-environmental quality value SMAEEI′ acquisition module, configured to screen out a plurality of monthly temperature values and a plurality of monthly precipitation values with the highest and second highest correlation with the SMAEEI, and construct a linear regression equation of the SMAEEI with the plurality of monthly temperature values and the plurality of monthly precipitation values by using a multiple regression model to obtain the simulated eco-environmental quality value SMAEEI′;
a unit area ecosystem service value coefficient VC_{if} acquisition module, configured to acquire the ecosystem service value equivalent coefficient E_{if} of the f-th ecosystem service function of the land cover type j in the area to be evaluated; based on the E_{if} and the preset standard ecosystem service value equivalent factor C_{crop} per unit area, the unit area ecosystem service value coefficient VC_{if} of the area to be evaluated is obtained;
an eco-environmental quality condition adjustment coefficient acquisition module, configured to construct a first eco-environmental quality condition adjustment coefficient R(Si,j,tₕ) based on the actual land cover classification result and the SMAEEI; based on the classification results of ideal land cover undisturbed by human beings and the simulated eco-environmental quality value SMAEEI′ in several years, the second eco-environmental quality condition adjustment coefficient R(Si,j,tₕ)′ is constructed;
an actual ecosystem service value ESV per unit area acquisition module, configured to obtain the actual ecosystem service value ESV per unit area of the area to be evaluated in several years through the unit area ecosystem service value coefficient VC_{if} of the area to be evaluated and the first eco-environmental quality condition adjustment coefficient R(Si,j,tₕ);
an acquisition module of the ideal ecosystem service value ESV′ per unit area, configured to obtain the ideal ecosystem service value ESV′ per unit area of the area to be evaluated in several years through the unit area ecosystem service value coefficient VC_{if} of the area to be evaluated and the second eco-environmental quality condition adjustment coefficient R(Si,j,tₕ)′; and
an ecosystem service value accumulation induced by anthropogenic factors (ESVA-AF) acquisition module, configured to obtain the ecosystem service value accumulation induced by natural factors (ESVA-NF) based on the ideal ecosystem service value ESV′ per unit area; based on the actual ecosystem service value ESV per unit area, the ecosystem service value accumulation induced by multiple factors (ESVA-MF) is obtained; residual analysis is carried out by using the ESVA-MF and the ESVA-NF to obtain the ESVA-AF.

In some embodiments, the remote sensing index includes related characterization parameters of land cover, soil characteristics, water environment, air pollution and vegetation status.

This disclosure offers the following advantages and beneficial effects:

(1) Based on the characteristics of semi-arid grasslands and surface mining areas, the disclosure selects representative remote sensing indexes from five aspects: land cover, soil characteristics, water environment, air pollution, and vegetation conditions. These indexes are used to construct a comprehensive environmental quality assessment index suitable for semi-arid grassland surface mining areas, known as the surface mining areas eco-environmental evaluation index (SMAEEI). This index is more aligned with the actual conditions on the ground in semi-arid grassland surface mining areas, is rich in local texture information, and is more consistent with the objective understanding of the hierarchy of ecological environment quality.

(2) The ecological cumulative effects evaluation model constructed by the disclosure uses SMAEEI as an adjustment coefficient for the ecological environment quality status. By establishing a coupling relationship between SMAEEI and natural factors such as precipitation and temperature, the model eliminates the cumulative impact of natural factors on the ecological environment of mining area. This avoids cumulative impact assessment errors caused by comprehensive factors and helps precisely identify the direction, degree, and spatial scope of ecological cumulative effects under human influence.

(3) The quantitative evaluation model for ecological cumulative effects uses the state of a natural ecosystem without human interference as the baseline. The assessment results represent the absolute ecological cumulant between comprehensive influences and natural influences at a specific research time point. Compared to the ecological cumulative relative variation, the absolute ecological cumulant proposed in this disclosure considers the cumulative effects of past human activities. Additionally, the ESVA-NF curve better matches the fluctuation state of natural ecosystems under only interannual climate influence, making it suitable for accurately assessing the cumulative impact of past and present human activities on ecosystems and eliminating the interference of significant interannual climate changes.

(4) The quantitative evaluation model for ecological cumulative effects converts the physical changes in the ecological environment caused by human activities (such as changes in land cover and ecological environment quality) into value descriptions (such as ecosystem service value). This monetization approach represents the intangible ecological damage costs of surface mining areas and enhances the comparability of assessment results under different mining durations, different mining conditions, and different human activities.

The application scenarios for the evaluation method and device of ecological cumulative effects in surface mining areas include:

(1) Comprehensive ecological environment quality assessment. A comprehensive evaluation of the ecological impact of mining involves assessing the effects of human activities such as mining on land, water resources, air quality, and biodiversity. The SMAEEI constructed by the disclosure can comprehensively assess the ecological environment quality of semi-arid grassland surface mining areas to some extent, objectively presenting the overall situation and spatiotemporal variation characteristics of the ecological environment quality in these areas.

(2) Time-series dynamic monitoring/Green mine evaluation. The SMAEEI and the ESVA-AF proposed in the disclosure can serve as quantitative indicators for time-series dynamic monitoring and green mine evaluation in semi-arid grassland surface mining areas. These indicators provide data support for horizontal comparisons of different research subjects at the same time point and vertical comparisons of the same research subject at different time points, helping to identify the long-term trends of ecological cumulative effects of major human activities in mining areas.

(3) Resource and environmental damage cost calculation. The quantitative evaluation model for ecological cumulative effects constructed by the disclosure represents the intangible ecological damage costs of surface mining areas in monetary terms. This quantification can provide information for formulating ecological compensation in mining areas and offer long-term auxiliary data support for calculating the GEP of mining areas.

(4) Support for sustainable mine management. The quantitative evaluation results of the ecological cumulative effects in mining areas provided by this disclosure offer insights into the direction, degree, and spatial scope of ecological cumulative impacts under different human influences. Mining companies can use this information to develop improvement strategies, reduce environmental burdens, and achieve sustainable mine management.

### BRIEF DESCRIPTION OF DRAWINGS

In order to explain the technical scheme of the embodiment of the present disclosure more clearly, the drawings needed in the description of the embodiment are briefly introduced below. Obviously, the drawings in the following description are only some embodiments of the present disclosure. For ordinary people in the field, other drawings can be obtained according to these drawings without creative work.

FIG. 1 is a schematic diagram of the location of the research area located in Xilinhot City, Xilingol League, Inner Mongolia Autonomous Region;

FIG. 2 is a flow chart of an evaluation method for ecological cumulative effects in surface mining areas provided by the embodiment of the application;

FIG. 3 is a schematic technical route diagram of the quantitative evaluation model for ecological cumulative effects in semi-arid grassland surface mining area provided by the embodiment of the application;

FIG. 4 is a schematic diagram of the difference between the applicability of surface mining areas eco-environmental evaluation index (SMAEEI) and eco-environmental evaluation indexes commonly used in semi-arid grassland mining areas in 2019;

FIG. 5 is a schematic diagram of the difference between the absolute ecological cumulant provided by the embodiment of the present application (a) and the ecological cumulative relative variation of the existing research (b);

FIG. 6 shows the change trend of the area ratio of different SMAEEI grades and the mean and standard deviation of SMAEEI from 1986 to 2020, provided by the embodiment of the application;

FIG. 7 is a schematic diagram of the spatial pattern of SMAEEI mean value and slope from 1986 to 2020 provided by the embodiment of the application;

FIG. 8 is a schematic diagram of the proportions of ESVA-AF levels of different research objects from 1986 to 2020 provided by the embodiment of the present application;

FIG. 9 is a schematic diagram of the spatial distribution of ESVA-AF grades from 1986 to 2020 provided by the embodiment of the present application;

FIG. 10 shows the ESVA-AF curves of different cumulative durations in the main human activity areas provided by the embodiment of the present application;

FIG. 11 is a schematic structural diagram of an evaluation device for ecological cumulative effects in surface mining areas provided by the embodiment of the present application.

### DETAILED DESCRIPTION OF EMBODIMENTS

In order to make the purpose, technical scheme and advantages of the embodiment of the application clearer, the technical scheme in the embodiment of the application will be described below with the attached drawings.

In the description of the embodiments of the present application, the words “exemplary”, “for example” or “take . . . as an example” are used to represent examples, illustrations or explanations. Any embodiment or design described as “exemplary”, “for example” or “take . . . as an example” among the embodiments of this application should not be interpreted as being more preferred or advantageous than other embodiments or designs. Specifically, the use of words such as “exemplary”, “for example” or “take . . . as an example” aims to present related concepts in a concrete way.

In the description of the embodiment of the present application, the term “and/or” is only an association relationship describing the associated objects, which means that there can be three relationships, for example, A and/or B, which can mean that A exists alone, B exists alone, and A and B exist at the same time. In addition, unless otherwise specified, the term “multiple” means two or more.

In addition, the terms “first” and “second” are only used for descriptive purposes, and cannot be understood as indicating or implying relative importance or implicitly indicating the indicated technical features. Therefore, the features defined as “first” and “second” may include one or more of these features explicitly or implicitly. The terms “including”, “comprising”, “having” and their variations all mean “including but not limited to” unless otherwise specifically emphasized.

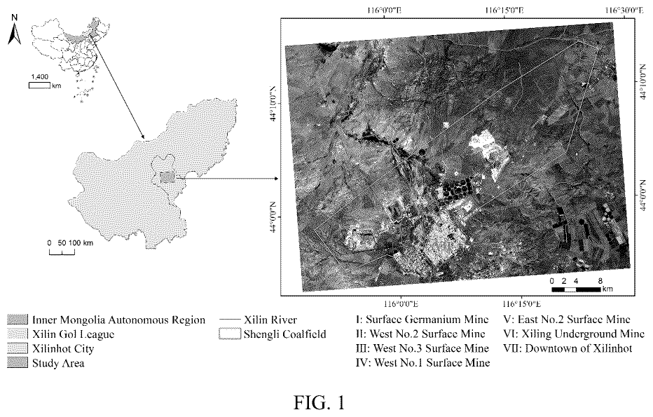

In order to clearly describe the application scheme, Shengli mining area in semi-arid grassland in eastern Inner Mongolia, China, which is located in the northern sand control belt of “three areas and four belts”, is taken as the research area to explain the application scheme. It can be understood that the application scheme is not limited to the above-mentioned Shengli mining area, but also applicable to other similar or related areas. For example, FIG. 1 is a schematic diagram of the location of the research area located in Xilinhot City, Xilingol League, Inner Mongolia Autonomous Region. As shown in FIG. 1, the study area is located in Xilinhot City, Xilingol League, Inner Mongolia Autonomous Region, between 43°53′-44° 15′N, 115° 49′-116° 28′E, including Shengli mining area in the northern suburb of Xilinhot downtown and its surrounding areas, with an area of 2211 km². Mining, agriculture, industry are distributed in the study area, which is a multi-source human activity area with mining as an important economic pillar. Shengli mining area is the thickest coal seam and the largest lignite coalfield in China with 22.59 billion t coal reserves. It is also one of the large coal-fired power bases in China. The mining area is in the northeast and southwest belt shape, with a total area of 342 km². The mines under exploitation include 4 surface coal mines, 1 surface germanium mine and 1 underground mine. The dominant landscape in the region is a typical semi-arid grassland. Xilin River runs through the study area from south to north, consisting of small wetlands, swamps, seasonal waters and saline-alkali land.

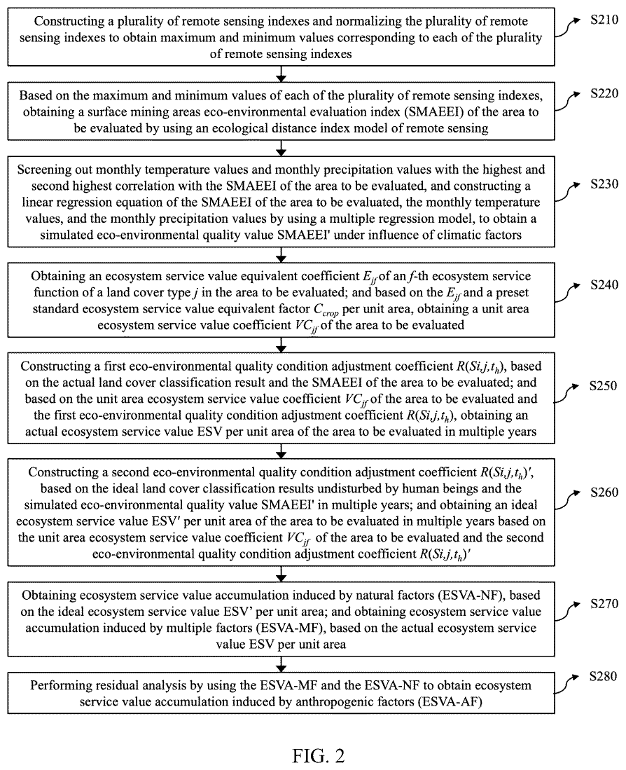

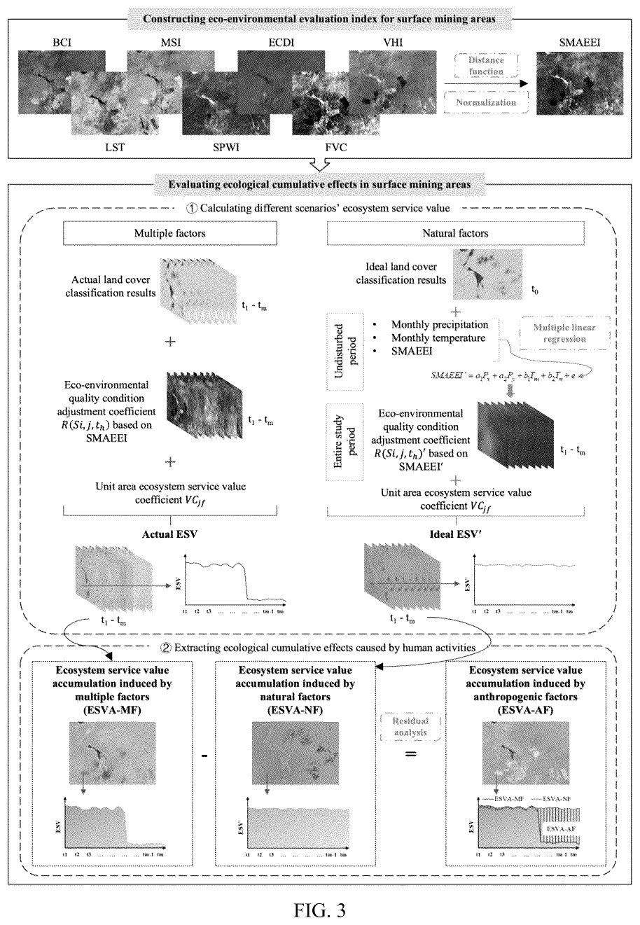

FIG. 2 is a schematic flow chart of an evaluation method for ecological cumulative effects of surface mining area provided by the embodiment of the application, which is applied to semi-arid grassland surface mining area. FIG. 3 is a schematic technical route diagram of a quantitative evaluation model for ecological cumulative effects in semi-arid grassland surface mining area provided by the embodiment of the application. As shown in FIGS. 2 and 3, the method includes steps S210-S280.

Among them, steps S210-S230 mainly introduce the construction process of surface mining areas eco-environmental evaluation index SMAEEI and simulated eco-environmental quality value SMAEEI′.

Step S210: Construct several remote sensing indexes and normalize them respectively to obtain the maximum and minimum values corresponding to each remote sensing index.

Semi-arid grassland surface mining area has the following ecological environment characteristics:
(1) Low and uneven precipitation, high evaporation rate and dry surface;
(2) Temperature changes dramatically;
(3) Serious land degradation such as soil salinization, desertification and soil erosion;
(4) Drainage leads to the transfer of underground water system and the decrease of surface runoff;
(5) Serious air pollution such as coal dust;
(6) The area of natural vegetation is reduced, and the ecological problems such as landscape damage are prominent.

In an embodiment, in combination with the above characteristics and the accessibility and representativeness of remote sensing data, the disclosure selects characteristic indexes from five aspects of land cover, soil characteristics, water environment, air pollution and vegetation status to construct the surface mining areas eco-environmental evaluation index (SMAEEI), and the relevant formulas and explanations are shown in Table 1 below.

TABLE 1
Formulas and explanations of SMAEEI (Target layer)

| Criteria | Indicator | | | Variable |
|---|---|---|---|---|
| layer | layer | Formulas | | description |
| Land cover | Biophysical Composition Index (BCI) | $BCI = \frac{( H + L ) / 2 - V}{( H + L ) / 2 + V}$ | (1) | H, L, and V are the normalized |
| | | | | brightness, |
| | | | | wetness, and |
| | | | | greenness of |
| | | | | tasseled cap |
| | | | | transformation, |
| | | | | respectively. |
| | | | | T is the |
| | | | | brightness |
| | | | | temperature |
| | | | | of the |
| | | | | thermal band |
| | | | | at the sensor. |
| | Land Surface Temperature | $LST = \frac{T}{1 + ( λ T / ρ ) ln ε}$ | (2) | λ is the central wavelength |
| | (LST) | | | of the |
| | | | | thermal band |
| | | | | (μm). |
| | | | | ρ = hc/ |
| | | | | k = 1.438 ×10⁻² |
| | | | | m·K, where |
| | | | | h is Planck |
| | | | | constant |
| | | | | (6.626 ×10⁻³⁴ |
| | | | | J·s), c is the |
| | | | | speed of |
| | | | | light |
| | | | | (2.998 × 10⁸ |
| | | | | m/s), k is |
| | | | | Boltzmann |
| | | | | constant |
| | | | | (1.38 × 10⁻²³ |
| | | | | J/K). ε is |
| | | | | the |
| | | | | emissivity. |
| | | | | SI is the |
| | | | | salinity |
| | | | | index. |
| | | | | ρ_{BLUE} and |
| Soil | Modified | SI = \sqrt{ρ_{BLUE} × ρ_{RED}} | (3) | ρ_{RED} are the |
| characteristics | Salinization | | | reflectance |
| | Index | | | of the |
| | (MSI) | | | Landsat blue |
| | | | | and red |
| | | | | bands, |
| | | | | respectively. |
| | | $MSAVI = \frac{( ( 2 {ρ}_{NIR} + 1 ) - \sqrt{{( 2 {ρ}_{NIR} + 1 )}^{2} - 8 ( {ρ}_{NIR} - {ρ}_{RED} )} )}{( 2 )}$ | (4) | MSAVI is the modified soil adjusted |
| | | | | vegetation |
| | | | | index. ρ_{NIR} |
| | | | | is the |
| | | | | reflectance |
| | | | | of the |
| | | | | Landsat |
| | | | | near-infrared |
| | | | | band. |
| | | MSI = \sqrt{(MSAVI - MSAVIₘₐₓ)² + SI²} | (5) | MSAVI and |
| | | | | MSAVIₘₐₓ |
| | | | | are the |
| | | | | normalized |
| | | | | MSAVI and |
| | | | | its maximum |
| | | | | value, |
| | | | | respectively. |
| | | | | SI is the |
| | | | | normalized |
| | | | | SI. |
| Water environment | Surface Potential | $SPWI = \frac{{ρ}_{NRI} - {ρ}_{SWIR 2} + {ρ}_{BLUE}}{{ρ}_{NIR} + {ρ}_{SWIR 2} + {ρ}_{BLUE}}$ | (6) | ρ_{SWIR2} is the reflectance |
| | Water | | | of the |
| | Abundance | | | Landsat |
| | Index | | | shortwave |
| | (SPWI) | | | infrared 2 |
| | | | | band. |
| Air pollution | Enhanced Coal Dust | $ECDI = \frac{{ρ}_{SWIR I} - {ρ}_{NIR} + {ρ}_{SWIR 2}}{{ρ}_{SWIR 1} + {ρ}_{NIR} - {ρ}_{SWIR 2}}$ | (7) | ρ_{SWIR1} is the reflectance |
| | Index | | | of the |
| | (ECDI) | | | Landsat |
| | | | | shortwave |
| | | | | infrared 1 |
| | | | | band. |
| Vegetation status | Fractional Vegetation | $NDVI = \frac{{ρ}_{NIR} - {ρ}_{RED}}{{ρ}_{NIR} + {ρ}_{RED}}$ | (8) | NDVI is the normalized |
| | Cover | | | difference |
| | (FVC) | | | vegetation |
| | | | | index. |
| | | $FVC = \frac{NDVI - {NDVI}_{soil}}{{NDVI}_{veg} - {NDVI}_{soil}}$ | (9) | NDVIₛₒᵢₗ and |
| | | | | NDVI_{veg} |
| | | | | are the |
| | | | | minimum |
| | | | | and |
| | | | | maximum |
| | | | | values of |
| | | | | NDVI, |
| | | | | respectively. |
| | | | | NRI is the |
| | | | | nitrogen |
| | | | | reflectance |
| | | | | index. |
| | Vegetative | NRI = ρ_{NIR}/ρ_{GREEN} | (10) | ρ_{GREEN} is |
| | Health | | | the |
| | Index | | | reflectance |
| | (VHI) | | | of the |
| | | | | Landsat |
| | | | | green band. |
| | | $NDSVI = \frac{{ρ}_{SWIR I} - {ρ}_{RED}}{{ρ}_{SWIR 1} + {ρ}_{RED}}$ | (11) | NDSVI is the |
| | | | | normalized |
| | | | | difference |
| | | | | senescent |
| | | | | vegetative |
| | | | | index. |
| | | VHI = f (NDVI, NRI, NDSVI) | (12) | NDVI, NRI |
| | | | | and |
| | | | | NDSVI are |
| | | | | normalized |
| | | | | values. |
| | | $VHI = \frac{PC 1 - PC {1}_{min}}{PC {1}_{max} - PC {1}_{min}}$ | (13) | PC1 is the first |
| | | | | component |
| | | | | of principal |
| | | | | component |
| | | | | analysis |
| | | | | (PCA). |
| | | | | PC1ₘᵢₙ and |
| | | | | PC1ₘₐₓ are |
| | | | | the minimum |
| | | | | and |
| | | | | maximum of |
| | | | | PC1 |
| | | | | respectively. |

In an embodiment, the remote sensing index can expand or replace related parameters according to demand and regional differences.

In a specific embodiment, the remote sensing indexes include the related characterization parameters of land cover, soil characteristics, water environment, air pollution, and vegetation status.

In a specific embodiment, the land cover condition is one of the most intuitive responses of the ecological environment in mining area to human activities such as mining disturbance, which is directly reflected in the change of land cover structure and indirectly reflected in the heat exchange between the ground and the air due to the change of underlying surface. For example, the biophysical composition index (BCI) and land surface temperature (LST) are selected for characterization respectively. For example, BCI is constructed by normalized brightness, greenness and wetness of tasseled cap transformation, which can effectively quantify vegetation abundance, distinguish impervious surface from soil, and reflect soil and vegetation humidity closely related to ecology, and the degree of surface “drying” caused by natural and human factors. LST is an important index to evaluate the ecological environment quality in arid areas, which can effectively measure climate change, surface drought and land desertification.

In a specific embodiment, the solid waste in mining area is easy to form soil salinization through erosion, leaching and evaporation, which aggravates the drought on the surface, resulting in the decline of soil fertility and the degradation of ecological environment. The modified salinization index (MSI) can effectively retrieve the soil salinity in arid areas. For example, MSI is selected to represent soil salinization phenomenon, reflecting the soil characteristics of semi-arid grassland mining area disturbed by climate change and human activities.

In a specific embodiment, it is important to evaluate the impact of surface water on surrounding environment and measure the ecological environment quality in arid and semi-arid areas where water resources are scarce. For example, in view of the fact that the surface potential water abundance index (SPWI) can solve the problem of abnormal values after water area fusion, and is closer to the real surface water source distribution than wetness, SPWI is selected to evaluate the surface water resource abundance.

In a specific embodiment, a large amount of coal dust produced by surface mining is one of the main sources of air pollution in mining areas. Coal dust will adhere to plant leaves or topsoil after migration and diffusion, which has a certain inhibitory effect on vegetation growth and soil animal survival. For example, in view of this, the enhanced coal dust index (ECDI) is introduced to identify the spatial distribution of coal dust pollution.

In a specific embodiment, the vegetation status is an indicator of the ecological environment quality in semi-arid mining areas. Vegetation coverage can reflect the impact of mining and reclamation activities on the ecological environment, and can reflect whether there is enough vegetation protection on topsoil. Vegetation health is helpful to distinguish the vegetation damage caused indirectly by mining, the difficulty of vegetation restoration caused by incomplete ecological restoration, and evaluate the degree of vegetation affected by soil erosion. For example, the fractional vegetation cover (FVC) and the vegetative health index (VHI) are selected to represent the vegetation status of surface mining area.

In a more specific embodiment, FVC is constructed by pixel dichotomy, and VHI is composed of normalized difference vegetation index (NDVI), normalized difference senescent vegetative index (NDSVI), and nitrogen reflectance index (NRI). Specifically, the above three indexes are normalized first, then the first principal component (PC1) is obtained by principal component analysis (PCA), and finally PC1 is normalized to obtain VHI.

The above seven remote sensing indexes need to be normalized first by Formula (14) before constructing comprehensive evaluation index,

$$I = \frac{I - {I}_{min}}{{I}_{max} - {I}_{min}} , \qquad ( 14 )$$

in this formula, I, Iₘᵢₙ and Iₘₐₓ are remote sensing index, its minimum and maximum, respectively.

Step S220: based on the maximum and minimum values of the remote sensing indexes, the ecological distance index model of remote sensing is used to obtain the SMAEEI.

When multiple indicators jointly determine the ecological environment, the shortcomings of the existing analysis methods are as follows. Subjective weighting methods such as analytic hierarchy process often have strong subjectivity and uncertainty. Objective weighting methods such as entropy weight method cannot deal with strong correlation between indicators. PCA is prone to ambiguity in the interpretation of ecological quality by various principal components.

The ecological distance index model of remote sensing based on distance function uses N remote sensing indexes to form an N-dimensional space, takes the minimum of positive index and the maximum of negative index as the worst point of ecological quality in the space, and judges the quality of ecological environment according to the distance from the rest space points to the worst point.

In an embodiment, the disclosure uses the ecological distance index model of remote sensing to overcome the defect in weighting, and uses the following formula (15) to obtain the SMAEEI,

$$SMAEEI = \sqrt{{( BCI - {BCI}_{max} )}^{2} + {( ECDI - {ECDI}_{max} )}^{2} + {( MSI - {MSI}_{max} )}^{2} + {( LST - {LST}_{max} )}^{2} + {( FVC - {FVC}_{min} )}^{2} + {( VHI - {VHI}_{min} )}^{2} + {( SPWI - {SPWI}_{min} )}^{2}} \qquad ( 15 )$$

Then the SMAEEI is normalized. The value range of SMAEEI is [0,1], and the greater the value, the better the ecological environment quality. For example, at the interval of 0.20, the SMAEEI is divided into five grades: poor (0.00-0.20), slightly poor (0.20-0.40), medium (0.40-0.60), good (0.60-0.80) and excellent (0.80-1.00).

Landsat series can be selected for multispectral remote sensing data, which can be obtained on the following platforms: Google Earth Engine (GEE) platform (https://code.earthengine.google.com/), U.S. Geological Survey (https://www.usgs.gov/), etc.

The selected images are USGS Landsat 5/7/8 Level2, Collection 2, Tier 1 surface reflectance data sets of GEE platform. The vegetation growing season images between June and September from 1986 to 2020 are selected with a spatial resolution of 30 m. Remote sensing image cloud detection CFMASK algorithm is used to mask clouds and cloud shadows, and mean synthesis is used to obtain image data of each year.

Whether SMAEEI can be used to construct the adjustment coefficient of ecological environment quality in the study area is determined by the comprehensive representation and applicability of SMAEEI in semi-arid grassland surface mining areas. Firstly, pearson correlation coefficient is used to analyze the average correlation between SMAEEI and each index (Table 2). The average correlation of the comprehensive index SMAEEI with the other seven indexes exceeds 0.71 each year, with a two-year average of 0.74, which is 0.04 and 0.15 higher than the two-year average of FVC (0.70) and seven single indexes (0.59), respectively. It shows that there is a higher average correlation between SMAEEI and each index, which can represent the information of each index more comprehensively than the other seven single indexes.

TABLE 2
Correlation coefficient matrix of indexes and SMAEEI in 2010 and 2015

| Year | Index | BCI | ECDI | FVC | VHI | MSI | SPWI | LST | SMAEEI |
|---|---|---|---|---|---|---|---|---|---|
| 2010 | BCI | 1.00 | 0.66** | −0.82** | −0.75** | 0.77** | −0.59** | 0.37** | −0.86** |
| | ECDI | 0.66** | 1.00 | −0.68** | −0.54** | 0.46** | −0.90** | 0.65** | −0.82** |
| | FVC | −0.82** | −0.68** | 1.00 | 0.87** | −0.83** | 0.60** | −0.40** | 0.94** |
| | VHI | −0.75** | −0.54** | 0.87** | 1.00 | −0.74** | 0.43** | −0.27** | 0.81** |
| | MSI | 0.77** | 0.46** | −0.83** | −0.74** | 1.00 | −0.25** | 0.03 | −0.69** |
| | SPWI | −0.59** | −0.90** | 0.60** | 0.43** | −0.25** | 1.00 | −0.84** | 0.81** |
| | LST | 0.37** | 0.65** | −0.40** | −0.27** | 0.03 | −0.84** | 1.00 | −0.66** |
| | Average | 0.66 | 0.65 | 0.70 | 0.60 | 0.51 | 0.60 | 0.43 | 0.76 |
| | correlation | | | | | | | | |
| 2015 | BCI | 1.00 | 0.46** | −0.85** | −0.85** | 0.91** | −0.35** | 0.42** | −0.86** |
| | ECDI | 0.46** | 1.00 | −0.54** | −0.45** | 0.54** | −0.50** | 0.51** | −0.57** |
| | FVC | −0.85** | −0.54** | 1.00 | 0.89** | −0.90** | 0.47** | −0.50** | 0.94** |
| | VHI | −0.85** | −0.45** | 0.89** | 1.00 | −0.90** | 0.40** | −0.37** | 0.90** |
| | MSI | 0.91** | 0.54** | −0.90** | −0.90** | 1.00 | −0.44** | 0.54** | −0.88** |
| | SPWI | −0.35** | −0.50** | 0.47** | 0.40** | −0.44* | 1.00 | −0.49** | 0.50** |
| | LST | 0.42** | 0.51** | −0.50** | −0.37** | 0.54** | −0.49** | 1.00 | −0.63** |
| | Average | 0.64 | 0.50 | 0.69 | 0.64 | 0.70 | 0.44 | 0.47 | 0.71 |
| | correlation | | | | | | | | |
| | Two-year | 0.65 | 0.57 | 0.70 | 0.62 | 0.61 | 0.52 | 0.45 | 0.74 |
| | average | | | | | | | | |
| | correlation | | | | | | | | |

Note:
**Significant correlation at 0.01 level (bilateral)

Secondly, remote sensing based ecological index (RSEI) and comprehensive ecological evaluation index (CEEI), which are widely used in urban environmental assessment, are selected. The arid remote sensing ecological index (ARSEI) constructed for the ecological environment in arid areas is also selected. Comparing the measurement results of the above indexes with SMAEEI in the study area, SMAEEI has the following applicability advantages in evaluating the ecological environment of semi-arid grassland surface mine.

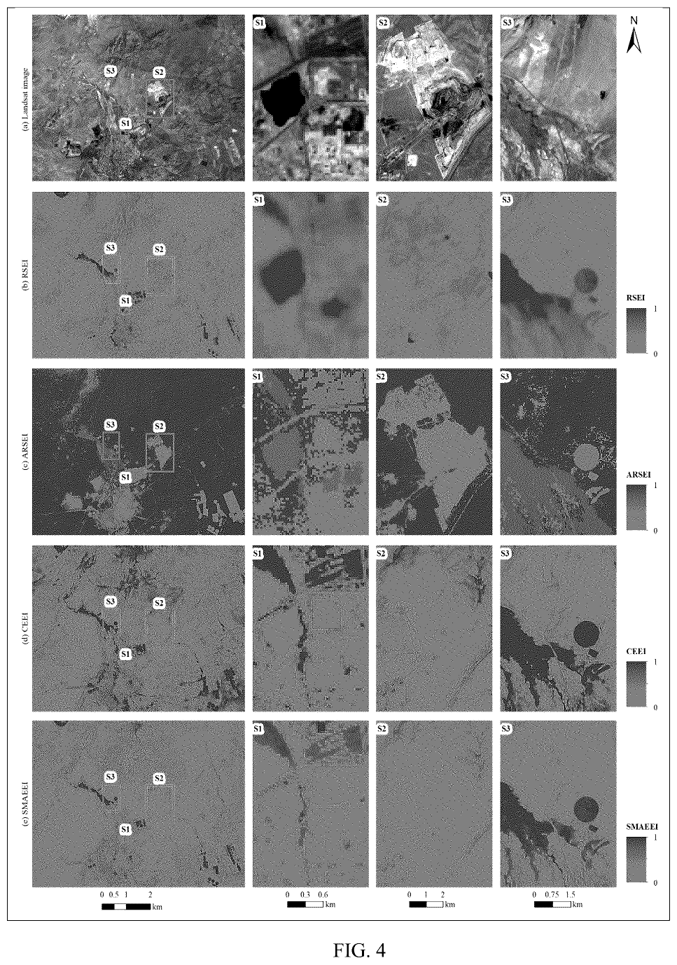

(1) The SMAEEI better matches the actual ground conditions and provides rich local texture information. FIG. 4 is a schematic diagram showing the difference between the applicability of the SMAEEI and the eco-environmental evaluation indexes commonly used in semi-arid grassland mining areas in 2019. As shown in FIG. 4, each index is different in the whole area, as well as local sample areas S1-S3. On the whole, CEEI and SMAEEI are closer to the real Landsat image, while RSEI overestimates the ecological environment quality of open-pit mines and developed areas, and ARSEI can hardly reflect the spatial heterogeneity of same land cover type. S1 is an artificial pond, and CEEI seriously underestimates the ecological environment quality of water area. SMAEEI is more in line with actual situation, which effectively distinguishes the ecological environment quality of water bodies from surrounding barren land and developed area, and details the texture change of pond from shallow to deep. S2 is East No. 2 Surface Mine, and the evaluation results of RSEI on surface mine and surrounding grassland are unfair. ARSEI, CEEI and SMAEEI are consistent with objective cognition, and SMAEEI can better reflect the step texture information of stope and dump compared with ARSEI and CEEI. S3 is a wetland and salinized area. RSEI and ARSEI can't capture salinization information effectively. CEEI and SMAEEI reflect the difference of ecological environment quality among wetland, cropland and salinized area, and SMAEEI is richer in wetland texture information. Considering the attenuation and gradual change of wetland on surrounding ecological environment with the increase of distance, SMAEEI conforms to the cognition of the first law of geography.

(2) The SMAEEI is more consistent with the objective cognition of ecological environment quality. Table 3 counts the average of each index for different land cover types in 2019. RSEI underestimates the ecological environment quality of grassland and overestimates the contribution of impervious surfaces such as barren land, developed land and mining land to the ecological environment. ARSEI overestimated the ecological environment quality of grassland, and failed to objectively reflect the differences between grassland and other vegetation types (such as woodland and wetland) in ecosystem service functions such as climate regulation and water conservation. CEEI can distinguish the eco-environmental quality of vegetation and non-vegetation types, but the range polarization is obvious, and the eco-environmental quality of water bodies is underestimated. The range distribution of SMAEEI is relatively balanced, and the order of eco-environmental quality in different areas from good to bad is: woodland/wetland >cropland >water bodies/grassland >developed land >barren land >mining land, which is consistent with previous research and objective cognition.

TABLE 3
Average of different indexes for all land cover types in 2019

| Land cover | | | | |
|---|---|---|---|---|
| type | RSEI | ARSEI | CEEI | SMAEEI |
| Barren land | 0.38 | 0.29 | 0.04 | 0.26 |
| Developed | 0.43 | 0.09 | 0.06 | 0.28 |
| land | | | | |
| Cropland | 0.54 | 0.49 | 0.90 | 0.69 |
| Woodland | 0.52 | 0.50 | 0.94 | 0.73 |
| Grassland | 0.25 | 0.97 | 0.35 | 0.37 |
| Mining land | 0.29 | 0.10 | 0.02 | 0.25 |
| Water bodies | 0.80 | 0.70 | 0.05 | 0.37 |
| Wetland | 0.54 | 0.76 | 0.95 | 0.72 |

In summary, the SMAEEI proposed in this disclosure demonstrates potential applicability in semi-arid grassland surface mining areas. It can quantitatively and objectively present the spatiotemporal changes in ecological environment quality and can be used to construct adjustment coefficients for the ecological environment quality status of the study area.

Step S230: select several monthly temperature values and several monthly precipitation values that have the highest and second-highest correlation with the SMAEEI. A multiple regression model is used to construct a linear regression equation between SMAEEI and the selected monthly temperature and precipitation values. This will yield the simulated ecological environment quality value under the influence of climatic factors, denoted as SMAEEI′.

According to the method, machine learning methods such as support vector machine and random forest can be adopted to carry out nonlinear modeling of the SMAEEI and a plurality of monthly values of temperature and precipitation, so that the fitting accuracy of the climate factor model is improved, and the deviation when separating human disturbance is reduced.

The change of ecological environment state in surface mining area results from the comprehensive action of natural conditions, mining and other human activities. It is difficult to completely eliminate the interference of human activities on the ecological environment and construct an ideal regression model between SMAEEI and natural factors in surface mining areas.

In an embodiment, because there were no high-intensity coal mining, urban expansion, or agricultural production activities in the study area from 1986 to 1990, this period more closely aligns with the ideal conditions for constructing an ideal regression model between SMAEEI and natural factors without human activity interference. Therefore, it is assumed that prior to 1990, the ecological environment status, climate factors, and human activities in the region maintained a balanced state. The study area, after masking areas used for mining, urban construction, and agriculture from 1986 to 1990, is considered a natural ecosystem without human interference. The spatial relationship between SMAEEI and climate factors during this period is constructed. For each pixel, the average values of the SMAEEI, monthly temperature, and monthly precipitation over these five years are calculated. The correlation coefficients between the SMAEEI and each month's temperature and precipitation are then determined. The two monthly temperature values and the two monthly precipitation values with the highest and second-highest correlations with SMAEEI are selected. A multiple regression model is used to construct the linear regression equation between SMAEEI and these temperature and precipitation values:

$${SMAEEI}^{′} = {a}_{1} {P}_{x} + {a}_{2} {P}_{y} + {b}_{1} {T}_{m} + {b}_{2} {T}_{n} + e \qquad ( 16 )$$

In this formula, SMAEEI′ is the simulated eco-environmental quality value under the influence of climatic factors. Pₓ and P_{y} (Tₘ, Tₙ) are the two monthly precipitation values (monthly temperature values) with the highest correlation and the second highest correlation with SMAEEI, respectively. a₁, a₂, b₁, b₂ and e are coefficients to be determined. The method for determining the values of the undetermined coefficients is as follows: substituting the SMAEEI average values of several years and the Pₓ average values, P_{y} average values, Tₘ average values and Tₙ average values of corresponding years into the linear regression equation to solve the values of the undetermined coefficients.

The monthly precipitation and monthly temperature data can be selected from National Earth System Science Data Center (http://www.geodata.cn/). In an embodiment, the monthly precipitation and monthly temperature data from 1986 to 2020 are selected with a resolution of 1 km, and the data are resampled to 30 m by cubic convolution interpolation and clipped to the study area. The SMAEEI has the highest correlation coefficient (0.76 and −0.78) with the precipitation in August and the temperature in March from 1986 to 1990, and the second highest with the precipitation in July and the temperature in December (0.76 and −0.77), all of which pass the significance test of p<0.01. Taking SMAEEI as dependent variable, precipitation in July and August and temperature in March and December as independent variables, a regression model of simulated eco-environmental quality value SMAEEI′ based on climatic conditions is established: SMAEEI′=−0.0001P₇+0.0002P₈−0.0058T₃−0.0007T₁₂−0.0037. The equation passed the p<0.01 significance test, with 0.61 R², 951089.15 F value and 0.01 s².

The following steps S240-S280 are the concrete processes of calculating the ecological cumulative effects of semi-arid grassland surface mining area. The calculation of ecological cumulative effects in surface mining area is subdivided into two steps: calculating the ecosystem service value of different scenarios and separating the ecological cumulative effects of human disturbance in mining area. Table 4 shows the formulas of the quantitative evaluation model for ecological cumulative effects in semi-arid grassland surface mining area.

TABLE 4
Formulas and explanations of quantitative evaluation model for
ecological cumulative effects in semi-arid grassland surface mining area

| Formulas | | Variable description |
|---|---|---|
| $FSV ( Si , j , {t}_{h} ) = {\sum }_{f = 1}^{q} {VC}_{jf} \times {A}_{Si} \times R ( Si , j , {t}_{h} )$ | (17) | Si(i= 1, 2, ... , n) represents the i-th pixel. j(j = 1, 2, ... , y) represents the j-th land cover |
| | | type. tₕ(h = 1, 2, ... , m) |
| | | represents the h-th research |
| | | time point, that is, the h-th |
| | | year. ESV(Si, j, tₕ) denotes |
| | | the ecosystem service value in |
| | | yuan for pixel i as land cover |
| | | type j in year h. VC_{jf}(f = 1, |
| | | 2, ... , q) is the unit area |
| | | ecosystem service value |
| | | coefficient (yuan/hm²) for the |
| | | f-th ecosystem service |
| | | function of land cover type j. |
| | | A_{S}_{ᵢ} indicates the area of pixel |
| | | (hm²), which is constant. |
| | | R(Si, j, tₕ) represents the |
| | | ecological environment |
| | | quality adjustment coefficient |
| | | for pixel i as land cover type j |
| | | in year h. |
| VC_{jf} = E_{jf} · C_{crop} | (18) | E_{jf} represents the ecosystem |
| | | service value equivalent |
| | | coefficient for the f-th |
| | | ecosystem service function of |
| | | land cover type j. C_{crop} is the |
| | | standard ecosystem service |
| | | value equivalent factor, |
| | | representing the economic |
| | | value (yuan/hm²) of the |
| | | natural grain yield per hectare |
| | | of cropland per year. |
| $R ( Si , j , {t}_{h} ) = \{ \begin{matrix}\frac{e ( Si , j , {t}_{h} )}{{e ( j , {t}_{h} )}_{mean}} & {E}_{jf} > 0 \\ \frac{{e ( j , {t}_{h} )}_{mean}}{e ( Si , j , {t}_{h} )} & {E}_{jf} < 0\end{matrix}$ | (19) | e(Si, j, tₕ) represents the ecological environment quality evaluation index for pixel i as land cover type j in |
| | | year h. e(j, tₕ)ₘₑₐₙ denotes |
| | | the average ecological |
| | | environment quality |
| | | evaluation index for all pixels |
| | | of land cover type j in year h. |
| | | EC_{Si} represent the ecosystem |
| | | service value accumulation. |
| | | z(z = 1, 2, ... , m − 1) represents |
| | | the z-th research period, |
| | | consisting of two consecutive |
| | | research time points. |
| ${EC}_{Si} = {\int }_{{t}_{1}}^{{t}_{2}} f [ ESV ( Si , j , 1 ) ] dt + … + {\int }_{{t}_{m - 1}}^{{t}_{m}} f [ ESV ( Si , j , m - 1 ) ] dt$ | (20) | f[ESV(Si, j, z)] is the ecosystem service value |
| | | function for pixel i remaining |
| | | as land cover type j during the |
| | | z-th research period, formed |
| | | by a linear function of the |
| | | ecosystem service value at the |
| | | start and end of the z-th |
| | | period. |
| | | ∫ₜ_{ₕ}^{t}^{ₕ₊₁} f[ESV (Si, j, z)]dt |
| | | represents the integral of the |
| | | ecosystem service value |
| | | function for pixel i as land |
| | | cover type j during the z-th |
| | | research period. |
| $Δ {EC}_{Si} = {EC}_{{Si}_{t}} - {EC}_{{Si}_{{t}_{0}}}$ | (21) | EC_{Si}_{ₜ} and [symbol] represent |
| | | the ecosystem service value |
| | | accumulation induced by |
| | | multiple factors (ESVA-MF) |
| | | and ecosystem service value |
| | | accumulation induced by |
| | | natural factors (ESVA-NF) of |
| | | the i-th pixel, respectively, |
| | | where t₀ is the research time |
| | | point before human |
| | | disturbance. ΔEC_{Si} is the |
| | | ecosystem service value |
| | | accumulation induced by |
| | | anthropogenic factors |
| | | (ESVA-AF) of the i-th pixel. A |
| | | value less than or greater than |
| | | 0 indicates a negative or |
| | | positive ecological cumulative |
| | | effects. |

Step S240: obtain the ecosystem service value equivalent coefficient E_{if} of the f-th ecosystem service function of land cover type j in the study area. Based on the E_{if} and the preset standard ecosystem service value equivalent factor C_{crop} per unit area, the unit area ecosystem service value coefficient VC_{if} of the study area is obtained.

In an embodiment, according to the sown area and yield of major grains (wheat, corn and rice) in Inner Mongolia in 2015, and the average price of major grain crops in the same year, the value of C_{crop} is 1613.61 yuan/hm².

In an embodiment, based on the classification system of the China National Land Use and Cover Change (CNLUCC) dataset and the actual characteristics of the study area, land cover types are divided into eight categories: water bodies, woodland, grassland, wetland, barren land, developed land, mining land, and cropland. Drawing on the research findings of experts like Gaodi Xie, the ecological service functions of the study area are categorized, and the ecosystem service value equivalent coefficients E_{if} for woodland, grassland, cropland, wetland, water bodies, and barren land are obtained. For mining land, as well as developed land, the ecosystem service value equivalent coefficients E_{if} for three functions-gas regulation, waste treatment, and water conservation—are estimated using indirect market methods such as the preventive cost method and the replacement cost method. The results of the ecological service function categorization for the study area and the ecosystem service value equivalent coefficients E_{if} for each land cover type are shown in Table 5.

TABLE 5
Ecosystem service value equivalent coefficients E_{jf} the study area

| Ecosystem | | | | | | | | |
|---|---|---|---|---|---|---|---|---|
| service | | | | | Water | Barren | Mining | Developed |
| function | Woodland | Grassland | Cropland | Wetland | bodies | land | land | land |
| Gas regulation | 4.32 | 1.50 | 0.72 | 2.41 | 0.51 | 0.06 | −3.35 | −0.85 |
| Climate | 4.07 | 1.56 | 0.97 | 13.55 | 2.06 | 0.13 | 0.00 | 0.00 |
| regulation | | | | | | | | |
| Water | 4.09 | 1.52 | 0.77 | 13.44 | 18.77 | 0.07 | −7.31 | −6.45 |
| conservation | | | | | | | | |
| Waste treatment | 1.72 | 1.32 | 1.39 | 14.40 | 14.85 | 0.26 | −4.67 | −0.55 |
| Soil formation | 4.02 | 2.24 | 1.47 | 1.99 | 0.41 | 0.17 | 0.00 | 0.00 |
| and protection | | | | | | | | |
| Biodiversity | 4.51 | 1.87 | 1.02 | 3.69 | 3.43 | 0.40 | 0.00 | 0.00 |
| protection | | | | | | | | |
| Food | 0.33 | 0.43 | 1.00 | 0.36 | 0.53 | 0.02 | 0.00 | 0.00 |
| production | | | | | | | | |
| Raw material | 2.98 | 0.36 | 0.39 | 0.24 | 0.35 | 0.04 | 0.00 | 0.00 |
| production | | | | | | | | |
| Entertainment | 2.08 | 0.87 | 0.17 | 4.69 | 4.44 | 0.24 | 0.00 | 0.00 |
| and culture | | | | | | | | |
| Total | 28.12 | 11.67 | 7.90 | 54.77 | 45.35 | 1.39 | −15.34 | −7.85 |

According to the ecosystem service value equivalent coefficient E_{if} and the standard ecosystem service value equivalent factor C_{crop} per unit area in Inner Mongolia, the unit area ecosystem service value coefficient VC_{if} in formula (18) in Table 4 is obtained. The regional VC_{if} is further revised by combining the biomass correction coefficient of cropland ecosystem in Inner Mongolia Autonomous Region of 0.44.

Step S250: constructing a first ecological environment quality condition adjustment coefficient R(Si,j,tₕ) based on the actual land cover classification result and the SMAEEI. The actual ecosystem service value ESV per unit area of the study area in several years is obtained through the unit area ecosystem service value coefficient VC_{if} of the study area and the first ecological environment quality condition adjustment coefficient R(Si,j,tₕ).

As shown in Table 4, the land cover classification results of each year and the SMAEEI are substituted into Formula (19) to construct the first ecological environment quality condition adjustment coefficient R(Si,j,tₕ) suitable for semi-arid grassland surface mining area, and then VC_{if} and R(Si,j, tₕ) are substituted into Formula (17) to obtain the actual ecosystem service value ESV of each year.

Step S260: constructing a second eco-environmental quality condition adjustment coefficient R(Si,j,tₕ)′ based on the ideal land cover classification result undisturbed by human beings and the simulated eco-environmental quality value SMAEEI′ in several years. The ideal ecosystem service value ESV′ per unit area of the study area in several years is obtained through the unit area ecosystem service value coefficient VC_{if} of the study area and the second ecological environment quality condition adjustment coefficient R(Si,j,tₕ)′.

In an embodiment, given that grassland is the dominant land type in the study area, it is assumed that the land cover type of the study area before human disturbance was primarily grassland. For this assumption, the areas affected by human activities in 1986, such as mining land, developed land, and cropland, are converted back to grassland. The remaining land cover types that were not disturbed by human activities are assumed to remain consistent with their state in 1986. This approach helps to construct an idealized land cover classification that represents the state of the area without human disturbance.

Obtaining the simulated eco-environmental quality value SMAEEI′ from 1986 to 2020: Taking the temperature and precipitation conditions of each year as different climate change scenarios, using the regression model SMAEEI′=−0.0001P₇+0.0002P₈−0.0058T₃−0.0007T₁₂−0.0037 to calculate. The ecological environment quality adjustment coefficient R(Si,j,tₕ)′ is constructed by using the classification result of ideal land cover undisturbed by human beings and the simulated eco-environmental quality value SMAEEI′ in each year, and then VC_{if} and R(Si,j,tₕ)′ are substituted into formula (17) in Table 4 to obtain the ideal ecosystem service value ESV′ influenced by natural factors in each year.

Step S270: based on the ideal ecosystem service value ESV′ per unit area, the ecosystem service value accumulation induced by natural factors (ESVA-NF) is obtained. Based on the actual ecosystem service value ESV per unit area, the ecosystem service value accumulation induced by multiple factors (ESVA-NW) is obtained.

In an embodiment, it is assumed that the cumulative effects caused by human activities (that is, the ecosystem service value accumulation induced by anthropogenic factors (ESVA-AF)) is equal to the residual between the actual value of ecological cumulative effects under comprehensive factors (that is, the ESVA-MF) and the ideal value of ecological cumulative effects under natural factors (that is, the ESVA-NF) without considering other non-decisive factors.

For example, ESV and ESV′ of each year are substituted into formula (20) in Table 4 to obtain ESVA-MF and ESVA-NF.

Step S280: residual analysis is carried out by using the ESVA-NW and the ESVA-NF to obtain the ESVA-AF.

Residual analysis is used to separate the cumulative effects of natural factors and human activities on the ecological environment of surface mining areas. In an embodiment, the difference is calculated by formula (21) in Table 4 to obtain the ESVA-AF under human interference during the whole research period, so as to reveal the degree and direction of cumulative effects.

It should be noted that the execution order of steps S250-S260 is not affected by the sequence, and the subsequent steps can be executed first without the results of the previous steps.

In an embodiment, the quantitative evaluation model for ecological cumulative effects in semi-arid grassland surface mining area can eliminate the coupling influence of climate factors on the ecosystem, and separate and quantify the cumulative effects of human activities on mining area ecosystem.

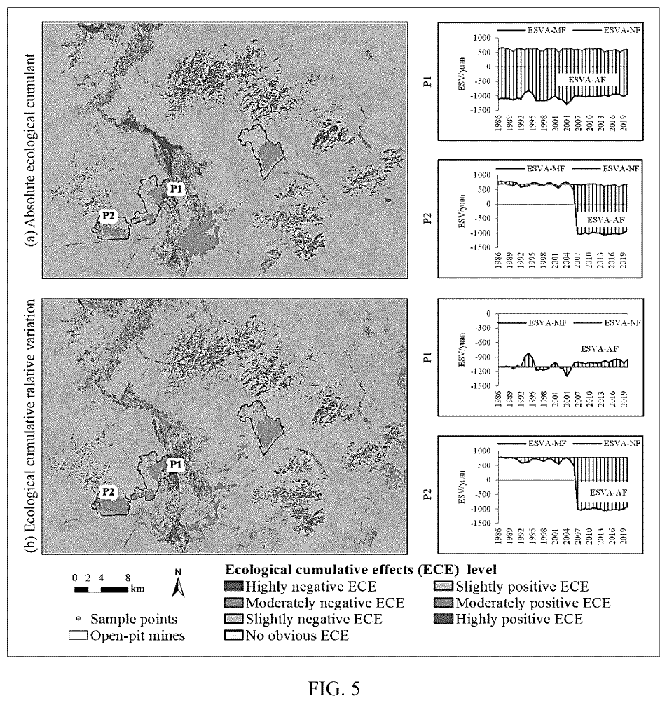

FIG. 5 is a schematic diagram of the difference between the absolute ecological cumulant provided by the embodiment of the present application (a) and the ecological cumulative relative variation of the existing research (b). At a macro level, the spatial distribution of the absolute ecological cumulant is relatively consistent with the ecological cumulative relative variation, but there are significant differences in the levels of ecological cumulative effects in areas such as West No. 1 Surface Mine, the old downtown, and some croplands.

At a micro level, for pixels like P1 that were mined before 1986, the absolute ecological cumulant uses the state of a natural ecosystem without human disturbance as the baseline and considers the cumulative impacts of past human activities. This aligns with the concept of ecological cumulative effects in mining areas, leading to more reasonable assessment results. On the other hand, the ecological cumulative relative variation uses the initial study period as the baseline, ignoring the impact of existing mining activities, thus underestimating the negative ecological cumulative effects.

For pixels like P2 that were mined after 1986, the absolute ecological cumulant is similar to the ecological cumulative relative variation. However, the baseline for the latter is a static value formed by a constant function, without considering the dynamic nature of time series, whereas the ESVA-NF curve for the former better matches the fluctuation state of a natural ecosystem under only interannual climate influence. In summary, the ecological cumulative relative variation are suitable for scenarios where there was no human activity at the beginning of the study and where interannual climate changes are not significant. Their results cannot separate the disturbance effects of human activities on regional ecology. The absolute ecological cumulant constructed by this disclosure is suitable for reasonably assessing the cumulative impacts of past and present human activities on ecosystems, and it can eliminate the interference of significant interannual climate changes in the region.

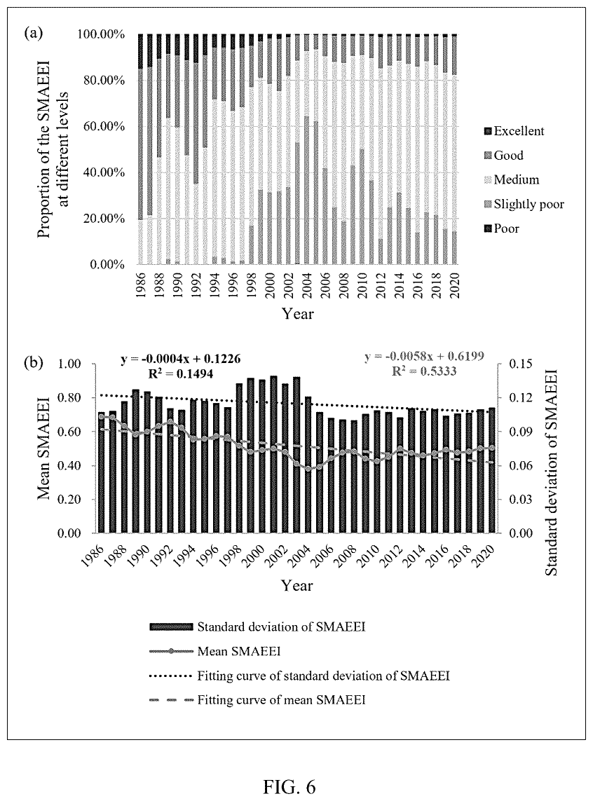

The results of this application are analyzed as follows. FIG. 6 shows the change trend of the area ratio of different SMAEEI grades and the mean and standard deviation of SMAEEI from 1986 to 2020 provided by the example of this application. In order to explore the overall eco-environmental quality in the study area, the area proportion of each SMAEEI grade from 1986 to 2020 is counted (referring to (a) of FIG. 6), and the mean and standard deviation of SMAEEI are linearly fitted (referring to (b) of FIG. 6). The eco-environmental quality in the study area is mainly medium grade, accounting for 53.33% on average, followed by good and slightly poor grades (21.69% and 21.09%). Excellent and poor grades are the lowest (3.85% and 0.04%). On the interannual change, the area of poor grade is basically stable. The area of slightly poor grade fluctuated greatly, which remained stable before 1997, gradually rose to the highest point from 1998 to 2004, and wavelike decreased from 2005 to 2020. In 1986-1997, the area of medium grade fluctuated and increased, and the change from 1998 to 2020 was opposite to that of poor grade, with a downward trend from 1998 to 2004 and an upward trend from 2005 to 2020. The change trends of areas for good and excellent grades are similar. The fluctuation dropped to the lowest point from 1986 to 2006, and rose slightly from 2007 to 2020. The slopes of the mean value and standard deviation of SMAEEI are negative (−0.0058 and −0.0004), respectively, indicating that the eco-environmental quality in the study area showed an extremely significant downward trend (p<0.01), and its spatial difference was significantly weakened (0.01<p<0.05).

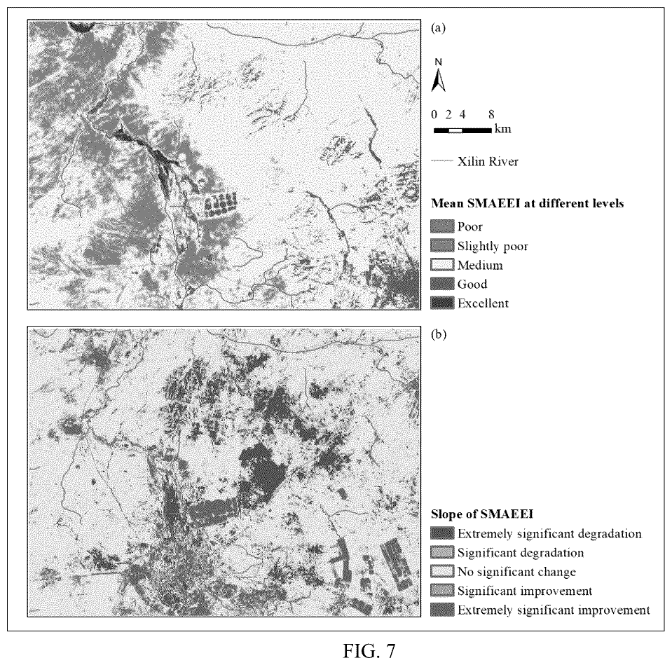

Analysis of the spatio-temporal variation characteristics of eco-environmental quality: The unary linear regression trend analysis method is used to simulate the variation trend of SMAEEI during the study period. The variation trend of SMAEEI is then divided according to its slope fitted by least square method and the significant result obtained by F test: extremely significant degradation (slope<0, p≤0.01), significant degradation (slope<0, 0.01<p≤0.05), no significant change (p>0.05), significant improvement (slope>0,0.01<p≤0.05) and extremely significant improvement (slope>0, p≤0.01). FIG. 7 is a schematic diagram of the spatial pattern of SMAEEI mean value and slope from 1986 to 2020 provided by the embodiment of the application. As shown in FIG. 7-a, the slightly poor grade of average SMAEEI from 1986 to 2020 is mainly concentrated in the west side of the study area, including grassland, mining land and developed land on both sides of Xilin River wetland. The good grades are scattered, mainly corresponding to wetland and cropland. The excellent grade is concentrated in Xilin River wetland. As shown in FIG. 7-b, the construction of mining land and the expansion of new urban areas have directly occupied the land, resulting in the destruction of vegetation, the rise of land surface temperature, and the extremely significant and significant degradation of regional ecological environment quality. In addition, due to the sharp increase in the number of livestock and overgrazing, the ecological environment quality of Xilin River wetland and grassland on the north side has also deteriorated significantly. The areas with significant and extremely significant improvement in ecological environment quality are mainly distributed in cropland, downtown, woodland and grassland around towns, and reclamation areas of north and south dump in West No. 1 Surface Mine.

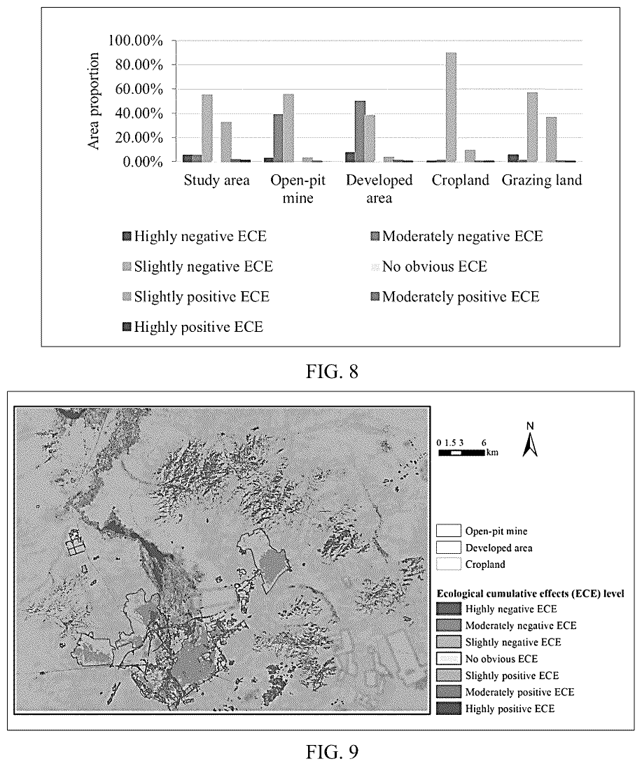

FIG. 8 is a schematic diagram of the proportion of ESVA-AF grades of different research objects from 1986 to 2020, and FIG. 9 is a schematic diagram of the spatial distribution of ESVA-AF grades from 1986 to 2020. In order to reveal the direction, degree and spatial heterogeneity of the ecological cumulative effects in the study area, ESVA-AF is divided into seven levels by using the natural breaking point method, which includes highly negative, moderately negative, slightly negative, insignificant, slightly positive, moderately positive and highly positive ecological cumulative effects. The overall and average situation of ESVA-AF (Table 6: Statistics of ESVA-AF and deviation for different research objects from 1986 to 2020) and the proportion of ESVA-AF at all levels (FIG. 8) are counted, and the spatial distribution of ESVA-AF is mapped (FIG. 9). From 1986 to 2020, the ESVA-AF in the study area decreased by 11,861.57 million yuan, which showed negative ecological cumulative effects, indicating that the ecosystem services and functions showed a downward trend compared with the natural ecosystem in the base period. Negative and positive ESVA-AF account for 65.42% and 34.55% of the total study area, respectively. Among the negative accumulation areas, the slightly negative accumulation area accounts for the largest proportion (55.07%), mainly concentrated in cropland, grassland on both sides of wetland, open-pit slope expansion area and dump, and the patches are distributed in a contiguous state. Followed by highly and moderately negative accumulation areas (5.24% and 5.11%), the former is scattered in wetland degradation areas, grassland degradation areas, urban expansion areas and the initial mining area of West No. 1 Surface Mine, and the latter is concentrated in the old town and open-pit mines. The proportion of low, medium and high grades in the positive accumulation area is 32.28%, 1.46% and 0.81%, respectively. The former mainly corresponds to grassland and part of cropland, while the latter two are concentrated in wetland.

TABLE 6
Statistics of ESVA-AF and deviation for different
research objects from 1986 to 2020

| | ESVA-AF | | | |
|---|---|---|---|---|
| Research | (million | Average pixel | Number | Average |
| objects | yuan) | ESVA-AF (yuan) | of pixels | deviation |
| Study area | −11861.57 | −4827.05 | 2457314 | / |
| Open-pit | −1067.08 | −13620.64 | 78343 | 1.82 |
| mines | | | | |
| Developed | −2155.50 | −21800.47 | 98874 | 3.52 |
| area | | | | |
| Cropland | −665.49 | −7414.46 | 89756 | 0.54 |
| Grazing | −8050.39 | −4037.76 | 1993776 | −0.16 |
| land | | | | |

As shown in FIG. 9, the range of open-pit mine, developed area and cropland is extracted according to the overlay results of land cover classification in each year, and the grassland after removing broken patches in 2020 is taken as the grazing land. Two analytical quantities, deviation degree and average annual change rate, are introduced to explore the differences of ecological cumulative effects in the areas directly affected by main human activities.

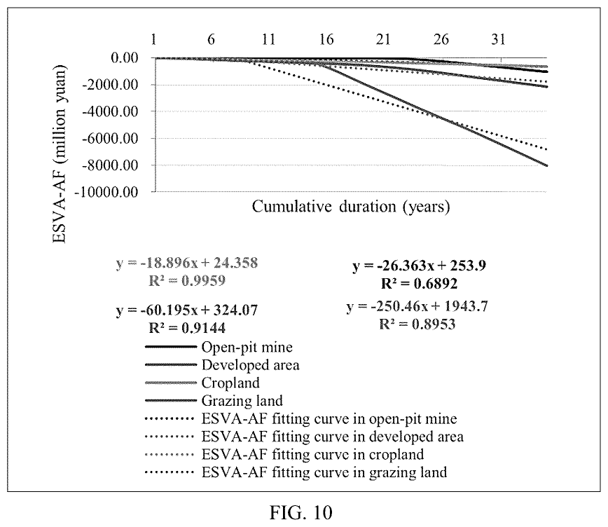

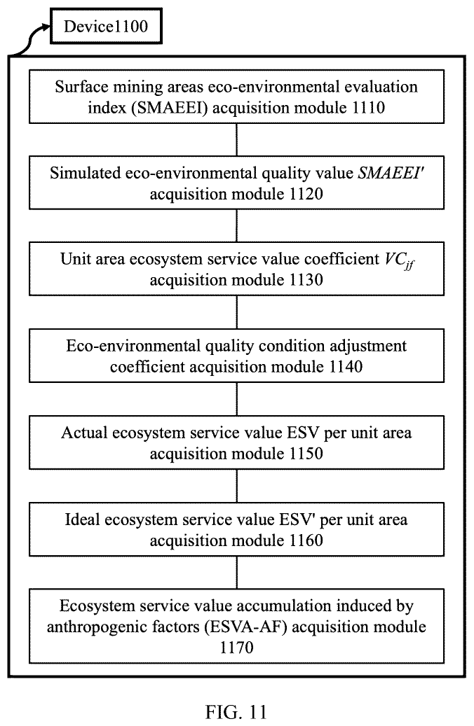

From 1986 to 2020, negative ecological cumulative effects appeared in the main human activity areas, but the difference was obvious. The overall ESVA-AF is cropland >open-pit mine>developed area>grazing land (Table 6). The average ESVA-AF per pixel is grazing land >cropland >open-pit mine>developed area. The negative accumulation area of open-pit mine is the largest (96.72%), followed by developed area, cropland and grazing land (95.20%, 90.60% and 62.96%) (FIG. 8). The deviation is calculated based on the pixel average ESVA-AF in the study area (−4827.05) (Table 6). The negative deviation (−0.16) in the grazing land shows that its stability of ecosystem services and functions is better than that of study area, while the rest areas are worse than study area, especially in developed area. FIG. 10 shows the ESVA-AF curves of different cumulative durations in the main human activity areas provided by the embodiment of the present application. By showing the ESVA-AF curves of different accumulation periods and the changes of their slopes in various human activity areas (FIG. 10), it can be known that the negative accumulation amount under the same accumulation period is grazing land >developed area>open-pit mines>cropland. According to the ESVA-AF curve, the average annual cumulative change rate of human activity areas in the past 35 years is further calculated, and the order from large to small is open-pit mine, grazing land, developed area and cropland (1758.68%, 666.04%, 198.50% and 100.05%), which shows that the negative cumulative change brought by surface mining in unit time is the most obvious.

In summary, from 1986 to 2020, the ecological environment quality in the study area showed a highly significant downward trend, with notable weakening of spatial differences. The ecological environment quality in surface mining areas, urban expansion zones, the Xilin River wetlands, and the northern grasslands exhibited highly significant and significant degradation trends. The ESVA-AF of the study area decreased by a total of 11,861.57 million yuan, indicating a negative ecological cumulative effect and a decline in ecosystem services and functions. The areas with negative and positive ESVA-AF accounted for 65.42% and 34.55%, respectively. High and moderate negative cumulative areas were concentrated in degraded wetland and grassland areas, urban zones, and surface mining areas. The negative ecological cumulative effects per unit area caused by surface mining and urban construction were the most pronounced, with surface mining causing the most intense negative cumulative changes per unit time, and urban construction showing the greatest local impact and deviation of negative cumulative effects. The ecosystem services and functions of both were unstable. Compared to surface mining, urban construction, and agricultural cultivation, grazing activities had the widest range and largest total negative ecological cumulative effects, but the local impact was the smallest, and the ecosystem services and functions were more stable.

Corresponding to the method provided by the disclosure, the disclosure also provides a device. FIG. 11 is a schematic structural diagram of an evaluation device of ecological cumulative effects of surface mining areas provided by the embodiment of this specification.

As shown in FIG. 11, the device 1100 includes:
a surface mining areas eco-environmental evaluation index (SMAEEI) acquisition module 1110, configured to construct several remote sensing indexes and normalize them respectively to obtain the maximum and minimum values corresponding to each remote sensing index. Based on the maximum and minimum values of the remote sensing indexes, the SMAEEI is obtained by using the ecological distance index model of remote sensing;
a simulated eco-environmental quality value SMAEEI′ acquisition module 1120, configured to screen out several monthly temperature values and several monthly precipitation values with the highest and second highest correlation with the SMAEEI, and construct a linear regression equation of the SMAEEI with the above several monthly temperature values and several monthly precipitation values by using a multiple regression model to obtain the simulated eco-environmental quality value SMAEEI′;
a unit area ecosystem service value coefficient VC_{if} obtaining module 1130, configured to obtain the ecosystem service value equivalent coefficient E_{if} of the f-th ecosystem service function of the land cover type j in the study area. Based on the E_{if} and the preset standard ecosystem service value equivalent factor C_{crop} per unit area, the unit area ecosystem service value coefficient VC_{if} of the study area is obtained;
an eco-environmental quality condition adjustment coefficient acquisition module 1140, configured to construct a first eco-environmental quality condition adjustment coefficient R(Si,j,tₕ) based on the actual land cover classification result and the SMAEEI. Based on the classification results of ideal land cover undisturbed by human beings and the simulated eco-environmental quality value SMAEEI′ in several years, the second eco-environmental quality condition adjustment coefficient R(Si,j,tₕ)′ is constructed;
an actual ecosystem service value ESV per unit area acquisition module 1150, configured to obtain the actual ecosystem service value ESV per unit area of the study area in several years through the unit area ecosystem service value coefficient VC_{if} of the study area and the first ecological environment quality condition adjustment coefficient R(Si,j,tₕ);
an acquisition module 1160 for the ideal ecosystem service value ESV′ per unit area, configured to obtain the ideal ecosystem service value ESV′ per unit area of the study area in several years through the unit area ecosystem service value coefficient VC_{if} of the study area and the second ecological environment quality condition adjustment coefficient R(Si,j,tₕ)′; and
an ecosystem service value accumulation induced by anthropogenic factors (ESVA-AF) obtaining module 1170, configured to obtain an ecosystem service value accumulation induced by natural factors (ESVA-NF) based on the ideal ecosystem service value ESV′ per unit area. Based on the actual ecosystem service value ESV per unit area, the ecosystem service value accumulation induced by multiple factors (ESVA-NW) is obtained. Residual analysis is carried out by using the ESVA-MF and the ESVA-NF to obtain the ESVA-AF.

It should be noted that for the description of the device in FIG. 11, please refer to the description of the aforementioned method.

In an embodiment, each of the above modules 1110-1170 of the device 1100 is embodied by a software stored in at least one memory and executable by at least one processor.

According to another aspect of the embodiment, there is also provided a computer-readable storage medium, on which a computer program is stored, which, when executed in a computer, causes the computer to perform the method described in connection with FIG. 2.

According to the embodiment of another perspective, there is also provided a computing device, which comprises a memory and a processor, wherein an executable code is stored in the memory, and when the executable code is executed by the processor, the method described in connection with FIG. 2 is realized. Those skilled in the art should realize that in one or more of the above examples, the functions described in the present disclosure can be realized by hardware, software, firmware or any combination thereof. When implemented in software, these functions can be stored in a computer-readable medium or transmitted as one or more instructions or codes on a computer-readable medium.

The specific embodiments described above further explain the purpose, technical scheme and beneficial effects of the present disclosure in detail. It should be understood that the above are only specific embodiments of the present disclosure and are not used to limit the protection scope of the present disclosure. Any modification, equivalent substitution, improvement, etc. made on the basis of the technical scheme of the present disclosure should be included in the protection scope of the present disclosure.

What is claimed is:

1. An evaluation method of ecological cumulative effects of surface mining areas, which takes a semi-arid grassland surface mining area as an area to be evaluated, the evaluation method comprises:
constructing a plurality of remote sensing indexes and normalizing the plurality of remote sensing indexes to obtain maximum and minimum values corresponding to each of the plurality of remote sensing indexes; the plurality of remote sensing indexes comprise related characterization parameters of land cover, soil characteristics, water environment, air pollution and vegetation status; the characterization parameters of the land cover are a biophysical composition index (BCI) and a land surface temperature (LST), wherein the BCI is constructed by a normalized brightness, greenness and wetness of tasseled cap transformation; the soil characteristics are characterized by a modified salinization index (MSI); the water environment is characterized by a surface potential water abundance index (SPWI); in the air pollution, an enhanced coal dust index (ECDI), which is capable of identifying an influence area of coal dust pollution, is used to identify a coal dust pollution degree; the vegetation status is characterized by a fractional vegetation cover (FVC) and a vegetation health index (VHI), and the FVC is constructed by pixel dichotomy, and the VHI is constructed by a normalized difference vegetation index (NDVI), a normalized difference senescent vegetative index (NDSVI) and a nitrogen reflectance index (NRI); a process for constructing the VHI comprises: normalizing the NDVI, the NDSVI and the NRI to obtain a normalized NDVI, a normalized NDSVI, and a normalized NRI, obtaining PC1 by performing principal component analysis (PCA) on the normalized NDVI, the normalized NDSVI, and the normalized NRI, and normalizing the PC1 to obtain the VHI, wherein PC1 is a first component obtained from the PCA;
obtaining, based on the maximum and minimum values of each of the plurality of remote sensing indexes, a surface mining areas eco-environmental evaluation index (SMAEEI) of the area to be evaluated by using an ecological distance index model of remote sensing, wherein a formula for the ecological distance index model of remote sensing is expressed as follows:
$$SMAEEI = \sqrt{{( BCI - {BCI}_{max} )}^{2} + {( ECDI - {ECDI}_{max} )}^{2} + {( MSI - {MSI}_{max} )}^{2} + {( LST - {LST}_{max} )}^{2} + {( FVC - {FVC}_{min} )}^{2} + {( VHI - {VHI}_{min} )}^{2} + {( SPWI - {SPWI}_{min} )}^{2}}$$
where I, Iₘᵢₙ, and Iₘₐₓ represent a corresponding one remote sensing index of the plurality of remote sensing indexes and a minimum value of the corresponding one remote sensing index and a maximum value of corresponding one remote sensing index, respectively, and
$$I = \frac{I - {I}_{min}}{{I}_{max} - {I}_{min}} ;$$
screening out monthly temperature values and monthly precipitation values with the highest and second highest correlation with the SMAEEI of the area to be evaluated, and constructing a linear regression equation of the SMAEEI of the area to be evaluated, the monthly temperature values, and the monthly precipitation values by using a multiple regression model, to obtain a simulated eco-environmental quality value SMAEEI′ influenced by climatic factors; wherein a calculation formula for determining the simulated eco-environmental quality value SMAEEI′ is: SMAEEI′ a₁Pₓ+a₂P_{y}+b₁Tₘ+b₂Tₙ+e, where Pₓ and P_{y} are respectively the monthly precipitation value with the highest correlation with the SMAEEI of the area to be evaluated and the monthly precipitation value with the second highest correlation with the SMAEEI of the area to be evaluated, Tₘ and Tₙ are respectively the monthly temperature value with the highest correlation with the SMAEEI of the area to be evaluated and the monthly temperature value with the second highest correlation with the SMAEEI of the area to be evaluated, and a₁, a₂, b₁, b₂ and e are undetermined coefficients;
obtaining an ecosystem service value equivalent coefficient E_{if} of an f-th ecosystem service function of a land cover type j in the area to be evaluated; and based on the E_{if} and a preset standard ecosystem service value equivalent factor C_{crop} per unit area, obtaining a unit area ecosystem service value coefficient VC_{if} of the area to be evaluated; the obtaining the E_{if} comprises: acquiring the ecosystem service value equivalent coefficient E_{if} of woodland, grassland, cropland, wetland, water bodies and barren land in a land cover classification result, and the ecosystem service value equivalent coefficient E_{if} of mining land and developed land corresponding to gas regulation, waste treatment and water conservation in the land cover classification result;
constructing a first eco-environmental quality condition adjustment coefficient R(Si,j,tₕ), based on an actual land cover classification result and the SMAEEI of the area to be evaluated; and based on the unit area ecosystem service value coefficient VC_{if} of the area to be evaluated and the first eco-environmental quality condition adjustment coefficient R(Si,j,tₕ), obtaining an actual ecosystem service value ESV per unit area of the area to be evaluated in multiple years;
constructing a second eco-environmental quality condition adjustment coefficient R(Si,j, tₕ)′, based on an ideal land cover classification results undisturbed by human beings and the simulated eco-environmental quality value SMAEEI′ in multiple years; and obtaining an ideal ecosystem service value ESV′ per unit area of the area to be evaluated in multiple years based on the unit area ecosystem service value coefficient VC_{if} of the area to be evaluated and the second eco-environmental quality condition adjustment coefficient R(Si,j, tₕ)′;
obtaining ecosystem service value accumulation induced by natural factors (ESVA-NF), based on the ideal ecosystem service value ESV′ per unit area; and obtaining ecosystem service value accumulation induced by multiple factors (ESVA-NW), based on the actual ecosystem service value ESV per unit area; and
performing residual analysis by using the ESVA-MF and the ESVA-NF to obtain ecosystem service value accumulation induced by anthropogenic factors (ESVA-AF).

2. The method according to claim 1, wherein the ecosystem service function comprises at least one selected from gas regulation, climate regulation, water conservation, waste treatment, soil formation and protection, biodiversity protection, food production, raw material production, and entertainment and culture.

3. An evaluation device for ecological cumulative effects of surface mining areas, which takes a semi-arid grassland surface mining area as an area to be evaluated, characterized in that, the device comprises:
a surface mining areas eco-environmental evaluation index (SMAEEI) acquisition module, configured to:
construct a plurality of remote sensing indexes and normalize the plurality of remote sensing indexes to obtain maximum and minimum values corresponding to each of the plurality of remote sensing indexes; the plurality of remote sensing indexes comprise related characterization parameters of land cover, soil characteristics, water environment, air pollution and vegetation status; the characterization parameters of the land cover are a biophysical composition index (BCI) and a land surface temperature (LST), wherein the BCI is constructed by a normalized brightness, greenness and wetness of tasseled cap transformation; the soil characteristics are characterized by a modified salinization index (MSI); the water environment is characterized by a surface potential water abundance index (SPWI); in the air pollution, an enhanced coal dust index (ECDI), which is capable of identifying an influence area of coal dust pollution, is used to identify a coal dust pollution degree; the vegetation status is characterized by a fractional vegetation cover (FVC) and a vegetation health index (VHI), and the FVC is constructed by pixel dichotomy, and the VHI is constructed by a normalized difference vegetation index (NDVI), a normalized difference senescent vegetative index (NDSVI) and a nitrogen reflectance index (NRI); a process for constructing the VHI comprises: normalizing the NDVI, the NDSVI and the NRI to obtain a normalized NDVI, a normalized NDSVI, and a normalized NRI, obtaining PC1 by performing principal component analysis (PCA) on the normalized NDVI, the normalized NDSVI, and the normalized NRI, and normalizing the PC1 to obtain the VHI, wherein the PC1 is a first component obtained from the PCA; and based on the maximum and minimum values of each of the plurality of remote sensing indexes, obtain an SMAEEI of the area to be evaluated by using an ecological distance index model of remote sensing; wherein a formula for the ecological distance index model of remote sensing is expressed as follows:
$$SMAEEI = \sqrt{{( BCI - {BCI}_{max} )}^{2} + {( ECDI - {ECDI}_{max} )}^{2} + {( MSI - {MSI}_{max} )}^{2} + {( LST - {LST}_{max} )}^{2} + {( FVC - {FVC}_{min} )}^{2} + {( VHI - {VHI}_{min} )}^{2} + {( SPWI - {SPWI}_{min} )}^{2}}$$
where I, Iₘᵢₙ and Iₘₐₓ represent a corresponding one remote sensing index of the plurality of remote sensing indexes and a minimum value of the corresponding one remote sensing index and a maximum value of the corresponding one remote sensing index, and
$$I = \frac{I - {I}_{min}}{{I}_{max} - {I}_{min}} ;$$
an acquisition module of a simulated eco-environmental quality value SMAEEI′, configured to:
screen out monthly temperature values and monthly precipitation values with the highest and second highest correlation with the SMAEEI of the area to be evaluated, and construct a linear regression equation of the SMAEEI of the area to be evaluated, the monthly temperature values, and the monthly precipitation values by using a multiple regression model to obtain the simulated eco-environmental quality value SMAEEI′; wherein a calculation formula for determining the simulated eco-environmental quality value SMAEEP′ is: SMAEEI′=a₁Pₓ+a₂P_{y}+b₁Tₘ+b₂Tₙ+e, where Pₓ and P_{y} are respectively the monthly precipitation value with the highest correlation with the SMAEEI of the area to be evaluated and the monthly precipitation value with the second highest correlation with the SMAEEI of the area to be evaluated, Tₘ and Tₙ are respectively the monthly temperature value with the highest correlation with the SMAEEI of the area to be evaluated and the monthly temperature value with the second highest correlation with the SMAEEI of the area to be evaluated, and a₁, a₂, b₁, b₂ and e are undetermined coefficients;
a unit area ecosystem service value coefficient VC_{if} acquisition module, configured to:
obtain an ecosystem service value equivalent coefficient E_{if} of an f-tₕ ecosystem service function of a land cover type j in the area to be evaluated; and based on the E_{if} and a preset standard ecosystem service value equivalent factor C_{crop} per unit area, obtain a unit area ecosystem service value coefficient VC_{if} of the area to be evaluated; a process for obtaining the E_{if} comprises: acquiring the ecosystem service value equivalent coefficient E_{if} of woodland, grassland, cropland, wetland, water bodies and barren land in a classification result of the land cover, and the ecosystem service value equivalent coefficient E_{if} of mining land and developed land corresponding to gas regulation, waste treatment and water conservation in the land cover classification result;
an eco-environmental quality condition adjustment coefficient acquisition module, configured to:
construct a first eco-environmental quality condition adjustment coefficient R(Si,j,tₕ), based on the actual land cover classification result and the SMAEEI of the area to be evaluated; and obtain a second eco-environmental quality condition adjustment coefficient R(Si,j,tₕ)′, based on the ideal land cover classification results undisturbed by human beings and the simulated eco-environmental quality value SMAEEI′ in multiple years;
an actual ecosystem service value ESV per unit area acquisition module, configured to:
based on the unit area ecosystem service value coefficient VC_{if} of the area to be evaluated and the first eco-environmental quality condition adjustment coefficient R(Si,j,tₕ), obtain an actual ecosystem service value ESV per unit area of the area to be evaluated in multiple years;
an acquisition module of the ideal ecosystem service value ESV′ per unit area, configured to:
obtain an ideal ecosystem service value ESV′ per unit area of the area to be evaluated in multiple years, based on the unit area ecosystem service value coefficient VC_{if} of the area to be evaluated and the second eco-environmental quality condition adjustment coefficient R(Si,j,tₕ)′; and
an ecosystem service value accumulation induced by anthropogenic factors (ESVA-AF) acquisition module, configured to:
based on the ideal ecosystem service value ESV′ per unit area, obtain an ecosystem service value accumulation induced by natural factors (ESVA-NF); based on the actual ecosystem service value ESV per unit area, obtain ecosystem service value accumulation induced by multiple factors (ESVA-MF); and perform residual analysis by using the ESVA-MF and the ESVA-NF to obtain the ESVA-AF.
